(19) United States
(12) Patent Application Publication
(10) Pub. No.: US 2018/0104891 A1
(43) Pub. Date: Apr. 19, 2018

(54) FUSED DEPOSITION MODELING PROCESS AND APPARATUS

(71) Applicant: BOND HIGH PERFORMANCE 3D TECHNOLOGY B.V., Zwolle (NL)

(72) Inventors: Thomas Jonathan BRUGGEMAN, Zwolle (NL); Adrianus BRUGGEMAN, Zwolle (NL)

(21) Appl. No.: 15/568,131

(22) PCT Filed: Apr. 20, 2016
(86) PCT No.: PCT/EP2016/058787

§ 371 Date: Oct. 20, 2017

(30) Foreign Application Priority Data
Apr. 20, 2015 (NL) 2014678

(51) Int. Cl. B29C 64/118; B29C 64/209; B29C 64/264; B29C 64/295; B29C 71/04; B29C 35/08; B33Y 10/00; B33Y 30/00

(52) U.S. Cl. CPC B29C 64/118; B29C 64/209; B29C 64/264; B33Y 30/00; B29C 71/04; B29C 35/0805; B33Y 10/00; B29C 64/295

(57) ABSTRACT

Method and system of fused deposition modeling an object including the steps of fused deposition modeling the object of a first fusible material; fused deposition modeling at least one heating element from a second fusible material comprising electromagnetic radiation absorptive material; exposing the heating element to electromagnetic radiation; wherein the fused deposition modeling the object and the fused deposition modeling the at least one heating element are performed by alternatively depositing layers of the object and the at least one heating element. Use of electromagnetic radiation absorptive material in fused deposition modeling.

### FIELD OF THE INVENTION

The invention relates to a use of electromagnetic susceptible material for fused deposition modeling, a method of fused deposition modeling and a system for fused deposition modeling.

### BACKGROUND OF THE INVENTION

In fused deposition modeling objects are formed by layering fusible material in a controlled manner such that a desired three dimensional shape can be created. This way of forming objects is sometimes also referred to as additive printing or fused deposition modelling. Very often for fused deposition modeling a fused deposition modeling printer is used. The printer has a three dimensionally moveable print head. The fusible material is usually fed in the print head in the form of filaments. The print head heats up fusible filament which is subsequently melted, extruded from the print head and deposited on the object on previously deposited layers where it is allowed to cool down and solidify. Thus a fused deposition modeled object grows with each deposited layer and gradually attains its desired shape.

Fusible materials used in the fused deposition modeling can have different thermal expansion coefficients in different production stages of the fused deposition modeled object. This causes mechanical tensions and warping during the printing and cooling down of the fused deposition modeled object.

The mechanical tensions and warping can be prevented by thermal conditioning of the fused deposition modeled object. The fused deposition modeled object can be held in a thermally conditioned space such as an oven, where it is held at a predefined temperature higher than the ambient temperature during the printing. After the printing the finished printed object is allowed to gradually cool off, thus maintaining its original shape without warping.

Holding a fused deposition modeled object in a thermally conditioned space may involve holding the fused deposition modeled object and a three dimensionally moveable fused deposition modeling print head in the thermally conditioned space together to allow the print head to form the fused deposition modeled object. The thermally conditioned space has to be large enough to accommodate both moveable print head and fused deposition modeled object. Substantially the same constant temperature has to be maintained throughout the space which is problematic in larger spaces. Furthermore sufficient printing accuracy has to be maintained in a temperature range sufficiently high for the printing process. Higher temperature ranges require large ovens involving high costs and as the deposition modeling printer is enclosed in the oven, accessibility to deposition modeling printer and fused deposition modeled object is reduced. Higher temperatures also accelerate the aging process of the deposition printer.

### SUMMARY OF THE INVENTION

It is therefore an object of the invention to prevent mechanical tension and warping of a fused deposition modeled object during fused deposition modeling of the fused deposition modeled object.

The object is achieved according to an aspect of the invention in a method of fused deposition modeling an object comprising
fused deposition modeling the object of a first fusible material;
fused deposition modeling at least one heating element from a second fusible material comprising electromagnetic radiation absorptive material;
exposing the heating element to electromagnetic radiation; wherein
the fused deposition modeling the object and the fused deposition modeling the at least one heating element are performed by alternatively depositing layers of the object and the at least one heating element.

The fusible materials of the object and heating element can be heated, melted and extruded using a fused deposition modeling (FDM) printer which can deposit the fusible on the object and heating element respectively. The FDM printer can use two FDM printheads for alternatively depositing the layers of fusible material for the object and heating element. The fused deposition modeled object formed as described by deposition printing can be heated by means of irradiating the heating element, i.e. applying an alternating electromagnetic field to the heating element, which transfers its heat to the object to maintain the object at an elevated temperature.

This allows the creation of fused deposition modeled objects, at least portions of which can be heated such that warping and tensile stress in the object can be relieved. The fused deposition modeled objects can gradually cool down after the fused deposition modeling process has ended. In an embodiment, the gradual cooling down can be facilitated by gradually reducing a strength of the electromagnetic radiation. When the object is cooled down, the heating element can be removed to expose and free the object.

In an embodiment, the exposing the heating element to electromagnetic radiation is performed during the fused deposition modeling the object and the fused deposition modeling the at least one heating element. This will heat up the object while the deposition of the object is on-going.

In an embodiment, the electromagnetic radiation comprises high frequency electromagnetic field (RF), and the electromagnetic radiation absorptive material comprises electromagnetically susceptive material. This electromagnetically susceptive material can be applied as a filler material in a FDM thermoplastic matrix, such that is can be fused deposition modeled in combination with the object.

This allows the heating element to be heated contactless with an RF electromagnetic field applied at a distance from the heating element and the object.

In an embodiment, the filler material can be a ferromagnetic material. The heating is caused by the remanence of the ferromagnetic material in which causes absorption of energy from the alternating electromagnetic field. In another embodiment, the filler material can be a low conductive material. In this case, the heating is caused by eddy currents in the low conductive material induced by the alternating electromagnetic field.

In an embodiment according to the invention the method further comprises fused deposition modeling the object around the heating element comprising electromagnetically susceptive fusible material. This allows the fused deposition modeled object to be heated from within the object, while the RF electromagnetic field permeates the object.

In a preferred embodiment according to the invention the method further comprises fused deposition modeling the heating element comprising electromagnetically susceptive fusible material around the at least one second part of the object modeled from fusible material in a heating layer or mantle. This allows the low-susceptive material inside to be kept warm at its periphery, where otherwise the greatest tension and warping would occur due to cooling down.

The heating element may comprise insulating material as a matrix, which allows the object to be thermally insulated.

In an embodiment according to the invention the exposing the heating element to electromagnetic radiation comprises
arranging an induction coil near the fused deposition modeled object,
activating the induction coil with a high frequency electric signal.

In a further embodiment according to the invention, the arranging an induction coil near the fused deposition modeled object comprises arranging an induction coil having its windings below the fused deposition modeled object. This allows easy access of the fused deposition modeled object from above the induction coil.

In another embodiment the arranging an induction coil near the fused deposition modeled object comprises arranging an induction coil having its windings laterally arranged with respect to the fused deposition modeled object. This allows easy access of the fused deposition modeled object from a side of the induction coil.

In another embodiment, the exposing the heating element to electromagnetic radiation comprises irradiating the heating element using infrared radiation, and the electromagnetic radiation absorptive material comprises infrared radiation absorptive material.

This allows efficient contactless heating of the heating element using Infrared (IR) lamps or similar sources arranged at a distance from the object and heating element.

In an embodiment, the infrared radiation absorptive material comprises a filler having a emissivity of at least 0.7. Preferably the emissivity of the filler is greater than 0.8. Even more preferably the emissivity is greater than 0.9.

In an embodiment, the method comprises fused deposition modeling the at least one heating element as a heating layer or mantle around the fused deposition modeled object.

In a further embodiment, the method comprises leaving an air gap between the object and the heating layer. This allows air or a gas to be introduced between the heating layer or mantle and the object. The heating layer is heated by the infrared radiation, which causes the heating layer to heat up. The so heated heating layer in its turn irradiates the object in the space within the heating layer or mantle by means of thermal, infrared radiation. Moreover, the inner wall of the heating layer or mantle causes the air within the inner space to heat up which causes heating of the object by convection of the air within that space.

In a further embodiment, the method comprises fused deposition modeling an infrared radiation transparent layer between the object and the heating layer. This allows the infrared radiation from the inner wall of the heating layer or mantle to be passed on to the object while preventing any air in the inner space between the heating layer or mantle and the object to flow. Such heated air would escape from the inner space in the clearing between the upper rim of object and heating layer by convection, causing an undesired drop in the temperature of the inner pace and thus of the object.

As an alternative embodiment, the method further comprises fused deposition modeling a heat conducting layer between the object and the heating layer. This allows heat from the heating layer or mantle to flow to the objet to be heated using heat conductivity, whilst heat loss of the object due to convection is prevented.

As a further embodiment, the method can further comprise covering the fused deposition modeled heating layer or mantle rim and the object rim. This prevents air flow and convection within the inner space between the heating layer or mantle and the object, thus heat loss of the object is prevented.

The object is also achieved according to another aspect of the invention by a system for fused deposition modeling an object, comprising a deposition modeling printing assembly comprising at least two deposition print heads, positioning means for positioning the deposition modeling printing assembly, at least one electromagnetic radiation source, and a stage for the object to be printed.

In an embodiment, the at least electromagnetic field generation device is an induction coil connected to a high frequency voltage supply. By applying an alternating voltage to the induction coil an alternating electromagnetic field is generated which can be used for heating electromagnetic susceptive material used in fused deposition modeling as described.

In another the induction coil is an induction coil having windings in a flat surface. This allows the induction coil to be arranged near the object to be formed by the system for fused deposition modeling, i.e. three dimensional printed, without occupying much space, keeping the system for fused deposition modeling compact.

In another embodiment, the induction coil is arranged underneath the object to be fused deposition modeled. Thereby the object is easily accessible and where necessary separated from the induction coil by the stage, platform and the like.

In another embodiment, the induction coil is arranged lateral to the object to be fused deposition modeled. Thereby the object is easily accessible from a side of the object.

In another embodiment, the two induction coils are laterally arranged on opposite sides of an object to be fused deposition modeled. This allows fused deposition modeled objects to be placed between the induction coils for better capture of the electromagnetic field generated by the coils.

In an embodiment, the at least one electromagnetic field source comprises an infrared radiation source.

In a further embodiment, the at least one infrared radiation source is arranged laterally of a heating element surrounding the object.

In an embodiment, the at least one infrared radiation source further comprises an infrared reflector arranged laterally of the heating element.

In another embodiment, the system further comprises a heater for heating a bottom part of the object to be fused deposition modeled. In a further embodiment, the heater is comprised in the stage.

In an embodiment, the system further comprises a heat cover connected to the at least two deposition print heads.

In a further embodiment, the heat cover comprises a heater.

The object is also achieved according to another aspect of the invention in a use of electromagnetic radiation absorptive fusible material in fused deposition modeling.

In an embodiment, the electromagnetic radiation absorptive fusible material comprises electromagnetic susceptive material.

In a further embodiment, the electromagnetic susceptive material comprises a filler comprising an ferromagnetic material.

In another embodiment, the electromagnetic radiation absorptive fusible material comprises a filler comprising infrared radiation absorptive material.

In an embodiment, the infrared radiation absorptive material comprises a filler having a emissivity of at least 0.7. Preferably the emissivity of the filler is greater than 0.8. Even more preferably the emissivity is greater than 0.9.

### BRIEF DESCRIPTION OF THE DRAWINGS

FIG. 1a shows a cross section of a fused deposition modeled object according to an embodiment according to the invention.

FIG. 1b shows a cross section of a fused deposition modeled object according to another embodiment according to the invention.

FIG. 1c shows a cross section of a fused deposition modeled object according to another embodiment according to the invention.

FIG. 1d shows the fused deposition modeled object of FIG. 1a in a perspective view.

FIG. 2a shows a fused deposition modeling system according to an embodiment of the invention.

FIG. 2b shows a fused deposition modeling system according to another embodiment of the invention.

FIG. 3 shows a side view of the fused deposition modeling system according to another embodiment of the invention.

FIG. 4 shows a top view of the used deposition modeling system according to the embodiment of the invention shown in FIG. 3.

FIG. 5 shows a portion of the fused deposition modeling system according to the embodiment of the invention shown in FIG. 3.

FIG. 6 shows a top view of the fused deposition modeling system according to the embodiment of the invention shown in FIG. 3.

### DETAILED DESCRIPTION OF EMBODIMENTS OF THE INVENTION

Fused Deposition Modeling Material

Fused deposition modeling filament for fused deposition modeling or three-dimensional additive printing can be made from fusible materials such as thermoplastic materials including ABS, HIPS, PLA, PVA, TPE, PA, PET, PK. Other fusible materials include for example metal alloys with low melting temperature such as tin, indium or bismuth alloys. In the art fused deposition modeling filaments made from these materials are heated and melted in a deposition modeling print head in a fused deposition modeling printer and extruded and deposited in a deposition modeling printer in layers to form a fused deposition modeled object. In order for fused deposition modeled objects or parts thereof made from these materials to be heated during the fused deposition modeling, heatable material can be arranged within or outside the fused deposition modeled object where heating is required, to prevent tension and/or warping.

WO2009002528 A1 describes method and material for inductively heating a composition of polymer and an electromagnetically susceptive filler, the filler comprising i.e. electrically conductive and/or ferromagnetic particles. The electromagnetically susceptive particles heat up when exposed to an alternating magnetic field due to hysteresis of ferromagnetic properties of the particles or in case of conductive material, by eddy currents in the material.

This type of electromagnetically susceptive material is used for induction welding of objects. In induction welding two parts made of this electromagnetically susceptive material are brought into contact with each other and the overlapping part is locally heated under pressure by means of a locally applied alternating high frequency electromagnetic field. The electromagnetically susceptive material melts where the electromagnetic field is applied and locally and bonds the parts together.

The fusible material can for example be the thermoplastics poly(etheretherketone), polyetherketoneketone, poly(etherim ide), polyphenylene sulfide, poly(sulfone), polyethylene terephthalate, polyester, polyamide, polypropylene, polyurethane, polyphenylene oxide, polycarbonate, polypropylene/polyamide, polypropylene/ethylene vinyl alcohol, polyethylene, polyolefin oligomers, liquid modified polyolefins or combinations thereof. From U.S. Pat. No. 6,048,599, cited in WO 2009002528 A1, electromagnetic susceptive additives, i.e. conductive and ferromagnetic particles known for electromagnetic fusion bonding include NiFe alloys and iron. Also ferromagnetic materials can be considered. Furthermore also fusible metal alloys with low melting temperature can be used such as tin, indium or bismuth alloys, enriched with electromagnetic susceptive additives as described.

This electromagnetically susceptive material can advantageously be made in for example a filament such that it can be used in known fused deposition modeling printers, i.e. three dimensional printers. The electromagnetically susceptive material can also be supplied for example in the form of rods or grains, depending on the requirements and capabilities of the fused deposition modeling printer used. The electromagnetic susceptive material can be deposited and arranged by fused deposition modeling into objects as required, which are inductively heatable during creation of once created by subjecting the objects to an alternating electromagnetic field.

Fused Deposition Modeling

The electromagnetic susceptive material can be used in creating objects from the electromagnetic susceptive material or from a combination of electromagnetic susceptive material and low susceptive fusible material. A fused deposition modeled object from electromagnetic susceptive material alone can be partly or wholly subjected to the alternating electromagnetic field. The alternating electromagnetic field has a certain limited penetration depth into the material, so it is preferred to also use low-susceptive fused deposition printing material and limit the use of the electromagnetic susceptive material. Below examples of objects made of such a combination of materials are described.

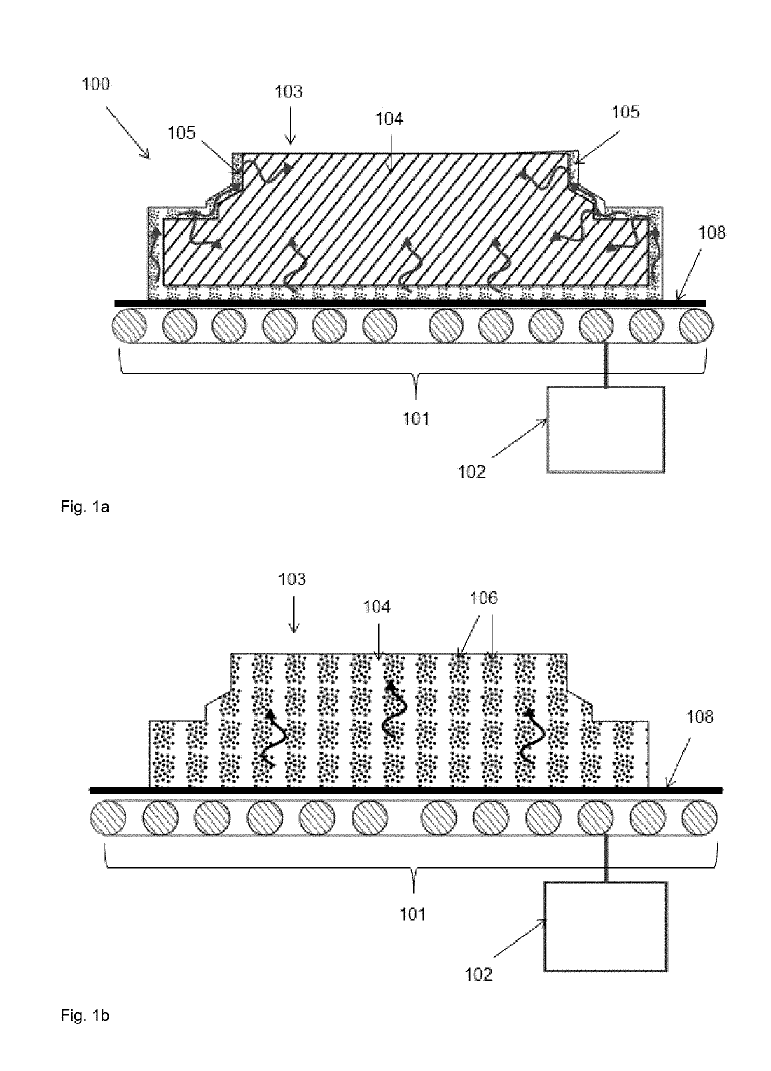

FIG. 1a shows a cross section of a fused deposition modeled object 103 which has been printed using the susceptive deposition modeling print filament. The fused deposition modeled object 103 comprises a body 104 which can be printed using standard fusible fused deposition modeling filament. The fused deposition modeled object can be covered with a conformal heating layer 105 of electromagnetic susceptive deposition material. The conformal heating layer 105 can be printed using a fusion deposition modeling print head of the deposition modeling printer. The conformal heating layer 105 can cover the fused deposition modeled object 103 partly such that only thermally sensitive parts of the object body 104 are covered or can cover all of the object body 104.

The conformal heating layer 105 of susceptive filament material can be printed adjacent to the fused deposition modeled object body 104 without contacting the fused deposition modeled object body material. After completing fused deposition modeling of the fused deposition modeled object, the conformal heating layer 105 can be easily removed. Furthermore, the conformal heating layer 105 can be additionally covered with a thermal insulation layer for preventing thermal losses during the fused deposition modeling and heating of the fused deposition modeled object 103. The conformal heating layer 105 and thermal insulation layer thus form a mantle around the fused deposition modeled object which may also provide structural support to the fused deposition modeled object 103 during the fused deposition modeling of the object 103.

FIG. 1b shows another example of a cross section of a fused deposition modeled object 103. The susceptive filament material is distributed throughout the fused deposition modeled object body 104, and is made by simultaneously or alternated printing layer by layer with standard fused deposition modeling filament, rods or granulate and susceptive filament rods or granulate material 106, or from susceptive filament material 106 alone.

When the induction coil 101 is excited, heat is generated inside the fused deposition modeled object causing an increased temperature. In this example, since the susceptive filament material is distributed over the entire fused deposition modeled object body 104, the increased temperature is also available throughout the entire fused deposition modeled object body 104.

FIG. 1c shows another example of a cross section of a fused deposition modeled object 103. The fused deposition modeled object 103 has pockets 107 of electromagnetic susceptive material printed in the fused deposition modeled object body 104. Thus specific parts of the fused deposition modeled object body 104 can be selectively heated by the induction coil 101 magnetic field.

The object 103 with the susceptive portions 105, 106 and 107 as described in the examples of FIGS. 1a-1d, can also be subjected by an alternating magnetic field from one or more alternatively positioned induction coils 101, depending on the structure of the fused deposition modeled object 103.

FIG. 1d shows the fused deposition modeled object of FIG. 1a in a perspective view. It shows that the conformal heating layer 105 of susceptive filament material can also partly cover the fused deposition modeled object body 104.

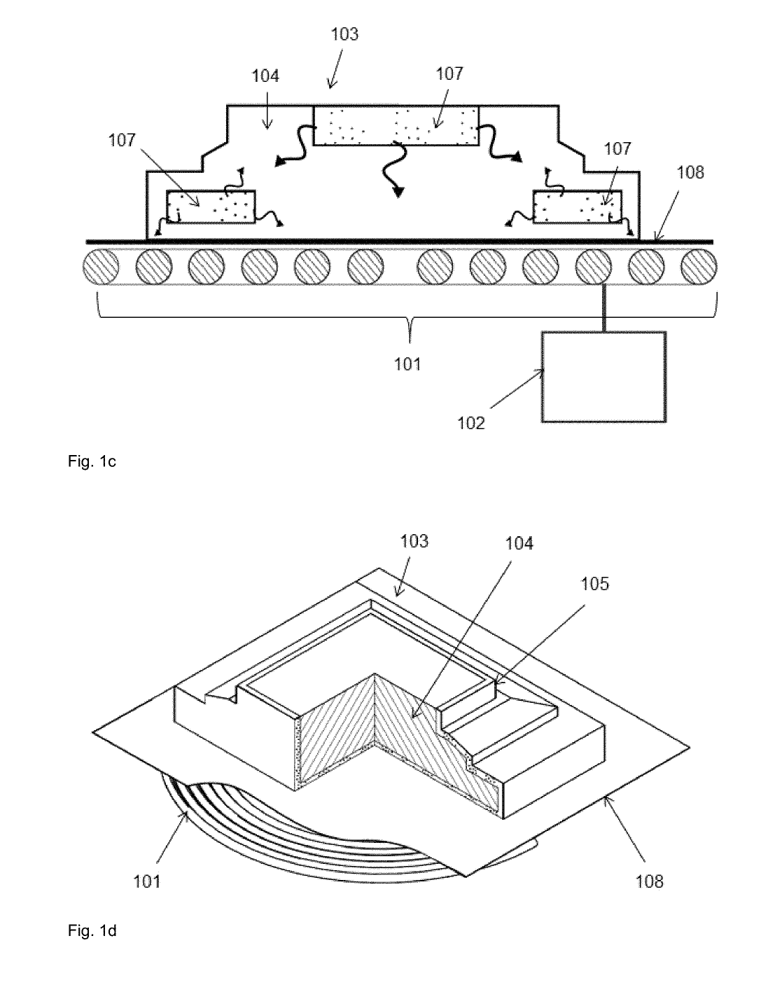

FIG. 2a shows an example of a fused deposition modeling system having an xyz-positioning device 201 for three dimensionally positioning a deposition print head assembly 202. The xyz-positioning device can be a three axis system having a horizontal axis (x), a vertical axis (z) and another horizontal axis (y) connected to the z-axis, arranged perpendicular to the x-axis. Many alternatives, such as robotic arms can be used as xyz-positioning device. The deposition print head assembly 202 connected to the xyz-positioning device has two or more deposition print heads 203a, 203b for fused deposition modeling an object 103 positioned on a stage 108. The deposition print heads 203a, 203b are arranged for extruding and depositing fusible filament 205a, and electromagnetically susceptive fusible material 205b on the object 103 to be modeled. The fusible material filament and electromagnetically susceptive fusible material filament 205a, 205b can be wound onto reels 204a, 204b for dispensing the filaments 205a, 205b to the deposition print heads 203a, 203b respectively. It will be recognized by the skilled person that other means and ways for dispensing the (non-susceptive) fusible material and/or electromagnetically susceptive fusible material are available such as for example in the form of grains, sticks or rods which can be fed into the deposition print heads.

A first deposition print head 203a can for example be used for forming the conformal heating layer 105 of electromagnetically susceptive fusible material as described under FIGS. 1a-1d, while the other print head 203b can be used for forming the actually desired object body 104 from the fusible material. Forming the conformal heating layer 105 and the object body can be performed simultaneously while the deposition print heads 203a, 203b are suitably positioned. Forming the conformal heating layer 105 and the object body 104 can also be performed by alternatively depositing material layers of the respective heating layer 105 and object body 104 while the deposition print heads 203a, 203b are being alternatively suitably positioned.

After forming the conformal heating layer 105, it can for example be subjected to an alternating magnetic field, generated by an induction coil 101 positioned underneath a stage 108 on which the fused deposition modeled object 103 is placed. The induction coil 101 can be inductively excited by a power supply 102 connected to the induction coil 101. The induction coil 101 can be made from conductive windings which are arranged in for example a flat surface. Such an induction coil can also be referred to as a ‘pancake’ coil. The conductive windings of the induction coil 101 can also be in an annular fashion below the fused deposition modeled object 103. The induction coil windings can be flat, annularly shaped or any other form is possible, including a rectangular shape or polygon shape.

FIG. 2b shows schematically an alternative arrangement for the induction coil 101. Various induction coil arrangements are possible depending on position, size, shape and heating requirements of the fused deposition modeled object 103. In FIG. 2b two induction coils 207a, 207b are placed on two opposite sides of an object 103, allowing a more uniform electromagnetic field to be created around the object 103, thereby heating the conformal heating layer 105 of electromagnetically susceptive material more uniformly. In FIG. 2b any fused deposition modeling printer details are not shown.

Alternatively to inductively heating the heating layer with a high frequency electromagnetic field, the heating layer can be heated using infrared electromagnetic radiation.

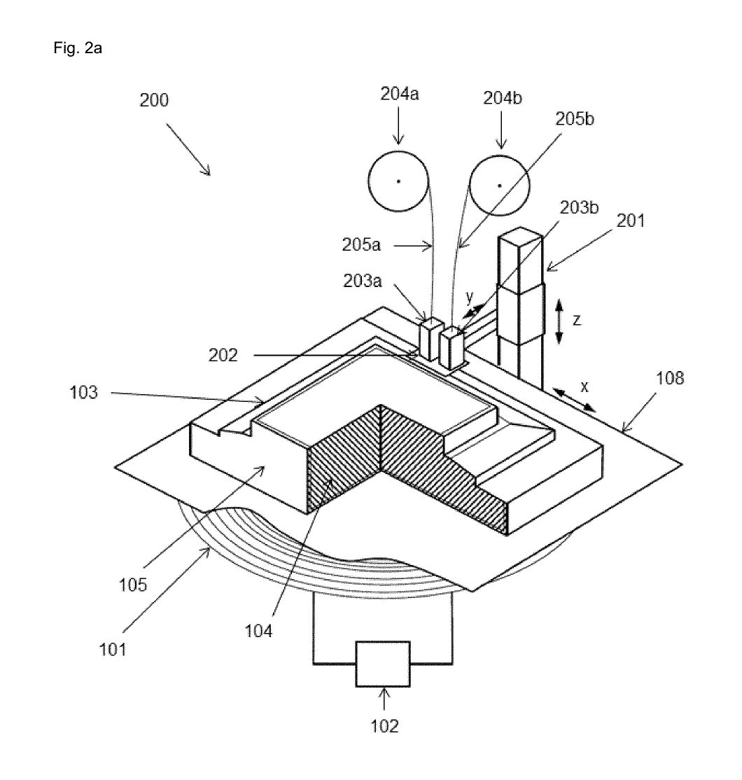

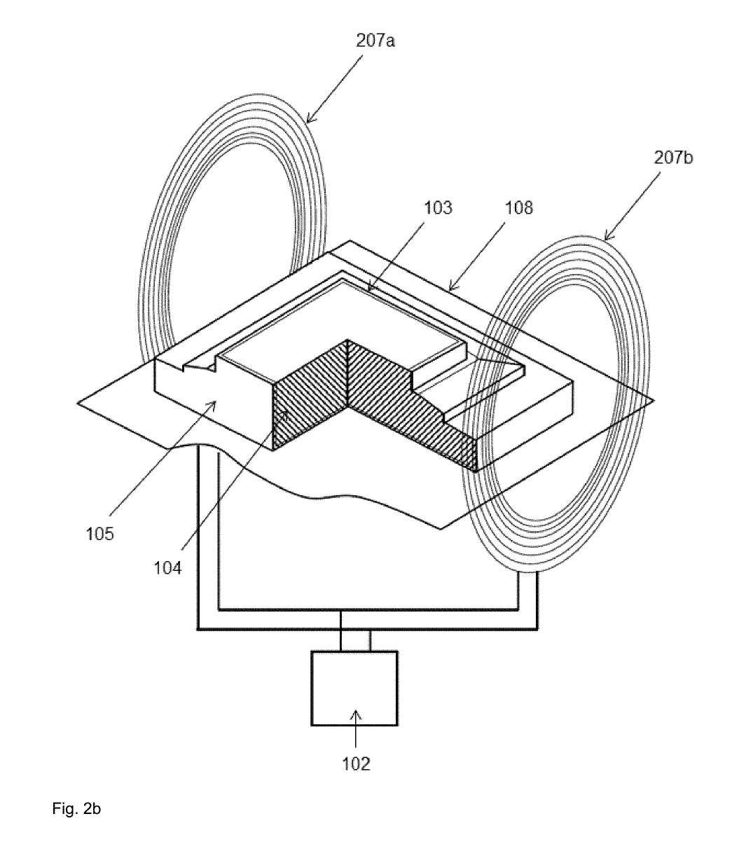

FIG. 3 shows a cross section of a fused deposition modeling system 300, wherein a heating layer 301 is shown, which can be irradiated by one or more infrared radiation sources 304. A fused deposition modeling object 302 is placed within the heating layer 301. The heating layer 301 can be conformal, following the contours of the object 302 as described above, however as shown in FIG. 3, the heating layer 301 can be arranged around the fused deposition modeling object 302 as a mantle without contacting the object 302. The heating layer 301 can cover the fused deposition modeled object 302 partly such that only thermally sensitive parts of the object body 302 are covered.

For the purpose of heating, the fused deposition modeling system 300 has infrared sources 304 posted laterally from the heating layer 301. The infrared sources 304 can for example be tubular infrared lamps, coiled filament lamps or heaters and the like for irradiating the infrared radiation having wave lengths in a mid-infrared wavelength range of 2 to 30 μm. The infrared radiation absorbed by the outer surface of the heating layer 301 heats up this heating layer or mantle 301 to a high temperature. Temperatures exceeding 100° C. or even 200° C. may be achieved for adequately heating and the object 302. The heat accumulated in the heating layer 301 is subsequently passed on to the fused deposition modeling object 302.

The material of heating layer 301 may contain an infrared absorbent filler such as outlined in Table 1 below:

TABLE 1
emissivity of infrared absorptive filler materials

| Filler | Filling grade (vol %) | Emissivity |
|---|---|---|
| Carbon black | >=40 | 0.8-0.98 |
| Black soot | >=40 | 0.95 |
| Graphite | >=20 | 0.97 |
| Graphene | >=10 | 0.99 |
| Glass | >=30 | 0.85-0.95 |

The filling grade of the filler must be sufficient to obtain an effective emissivity of at least 0.8 and preferably at least 0.9 which is sufficient for use as heating element 301 or mantle.

As a thermoplastic matrix a material can be used which has its VICAT temperature above 170° C. This allows a structure deposited as heating element to maintain its shape at a workable temperature. Exemplary materials are PET, PA6 and PA66, which are also non-toxic and relatively cheap. Recyclates of these materials are well suited for use in heating elements as described.

The infrared radiation can be combined with heating the stage 305 of the fused deposition modeling object 302 from below the stage 305 on which the object 302 is positioned using a heater.

The fused deposition modeling printhead 303 can be equipped with a heat cover 306 attached to the printhead 303. The heat cover 306 is provided with a passage for the printhead 303 and can be adjustable in height relative to the printhead nozzle. As printing progresses, the fused deposition modeling object 302 and heating layer 301 have an increasing height. Since the heat cover 306 is attached to the printhead 303, the heat cover has a fixed distance to the top of the fused deposition modeling object 302 and heating layer 301 respectively. This distance or gap 308 can be chosen in a small distance range d such as 0.1 mm to a few mm. The smaller the gap 308 the better the heat cover 306 prevents air convection from the space 307 between the fused deposition modeling object 302 and heating layer 301, cooling down an inner side of the heating layer 301 and the object 302.

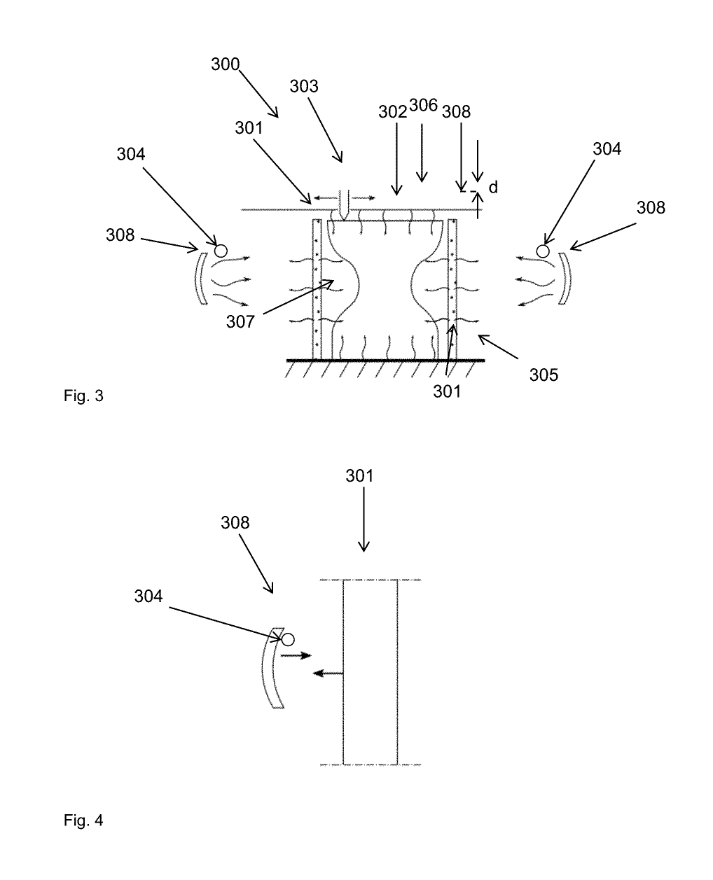

FIG. 5 shows a portion of the fused deposition modeling system 300 of FIG. 3, wherein the space 307 is filled with an infrared transparent material 501. Sodium or potassium salts such a for example sodium or potassium acetates or chlorides will perform well in fused deposition modeling the salts between the object 302 and the heating element or mantle 301. These salts may be dissolved easily in water after finishing the fused deposition modeling. Moreover, heat conducting materials may also be fused deposition modeled or dispensed within space 307. Example of such materials are mixtures of PEG, PEO, Methyl Cellulose/Alum ide emulsion or silicon oil.

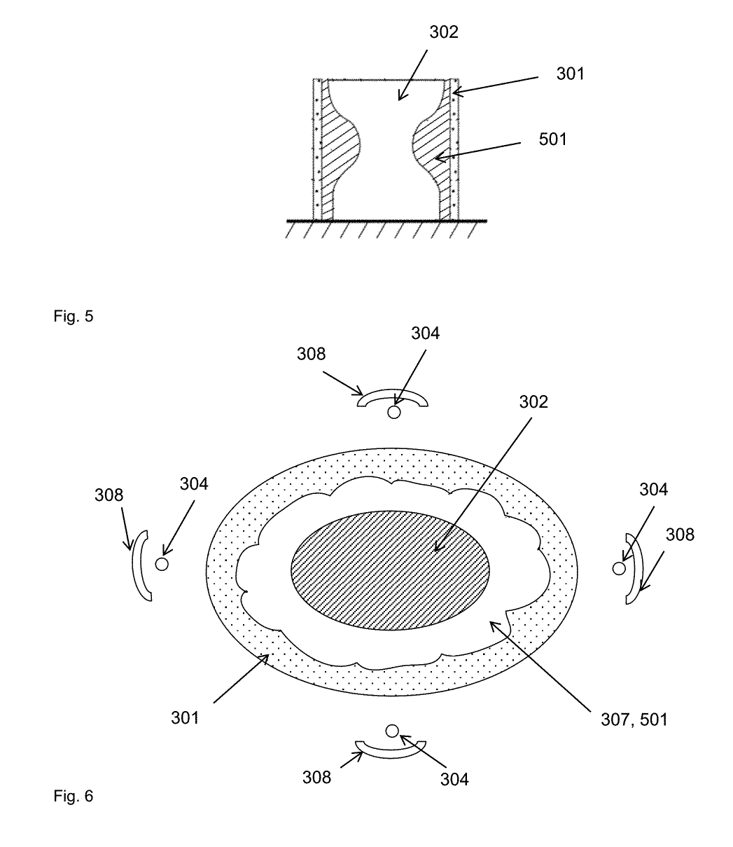

FIG. 6 shows a top view of the fused deposition modeling system 300 of FIG. 3. In the center the object 302 to be printed and heated is shown. Surrounding the object 302, the heating element or mantle 301 is shown. The heating element 301 has a smooth, curved outer circumference to avoid shading of the IR-radiation from the IR sources 304. The reflectors 308 can be arranged to evenly distribute the IR-radiation beams from the respective IR sources over the heating layer outer surface. Depending on the heating layer shape, the mutual arrangement of the IR-sources 304 and reflectors 308 may be adapted to highlight particular parts of the heating layer 301. The inner circumference of the heating element 301 may have an irregular shape, depending on the outer circumference of the object 302 to be printed. In this particular example a smooth, curved inner circumference would have been adequate for heating the object. As described, the space 307 between the heating element 301 and the object to be printed may be filled up with a infrared transparent or heat conducting material.

The above embodiments are described by way of example only. Variations thereof are possible without departing from the scope of protection as defined by the claims set out below.

### REFERENCE NUMERALS

100 fused deposition modeling system
101 induction heating coil
102 high frequency power supply
103 fused deposition modeled object
104 fused deposition modeled object body
105 conformal heating layer
106 electromagnetic susceptive material
107 susceptive pockets
108 stage
200 fused deposition modeling system
201 xyz-positioning device
202 print head holder
203a, 203b print head
204a, 204b filament reel
205a, 205b fused deposition modeling filament
207a, 207b induction heating coil
300 fused deposition modeling system
301 heating layer
302 fused deposition modeled object
303 fused deposition printhead
304 infrared radiation source
305 stage
306 heat cover
307 space
308 reflector
501 IR transparent or heat conductive layer

What is claimed is:

1. A method of fused deposition modeling an object comprising the steps of:
fused deposition modeling the object of a first fusible material;
fused deposition modeling at least one heating element from a second fusible material comprising electromagnetic radiation absorptive material;
exposing the heating element to electromagnetic radiation; wherein
the fused deposition modeling the object and the fused deposition modeling the at least one heating element are performed by depositing layers of the object and the at least one heating element alternatively;
the method further comprising removing the heating element.

2. (canceled)

3. The method according to claim 1, wherein the exposing the heating element to electromagnetic radiation comprises irradiating the heating element using infrared radiation, and wherein the electromagnetic radiation absorptive material comprises infrared radiation absorptive material.

4. The method according to claim 1, further comprising gradually reducing a strength of the electromagnetic radiation after completing the steps of the method of claim 1.

5. (canceled)

6. (canceled)

7. The method according to claim 1, further comprising fused deposition modeling the at least one heating element as a heating layer around the fused deposition modeled object.

8. (canceled)

9. (canceled)

10. (canceled)

11. (canceled)

12. The method according to claim 3, wherein the infrared radiation absorptive material comprises a filler having a emissivity of at least 0.8.

13. (canceled)

14. (canceled)

15. The method according to claim 3, further comprising leaving an air gap between the object and the heating layer.

16. The method according to claim 3, further comprising fused deposition modeling an infrared radiation transparent layer between the object and the heating layer.

17. The method according to claim 3, further comprising fused deposition modeling a heat conducting layer between the object and the heating layer.

18. A system for fused deposition modeling, comprising:
a deposition modeling printing assembly comprising at least two deposition print heads;
positioning means for positioning the deposition modeling printing assembly;
at least one electromagnetic radiation source;
a power supply for supplying the at least one electromagnetic radiation source;
a control unit, wherein the control unit is arranged for controlling the positioning means, the at least two deposition printheads, and the at least one electromagnetic radiation source, for:
fused deposition modeling the object from a first material;
fused deposition modeling at least one heating element from electromagnetic radiation absorptive material;
exposing the heating element to electromagnetic radiation from the electromagnetic radiation source; wherein
the fused deposition modeling the object and the fused deposition modeling the at least one heating element are performed by depositing layers of the object and the at least one heating element alternatively;
the at least one electromagnetic radiation source comprising an infrared radiation source.

19. (canceled)

20. (canceled)

21. (canceled)

22. (canceled)

23. (canceled)

24. (canceled)

25. The system according to claim 18, wherein at least one infrared radiation source is arranged laterally of the heating element.

26. The system according to claim 25, further comprising an infrared reflector arranged laterally of the heating element.

27. The system according to claim 18, further comprising a heater for heating a bottom part of the object to be fused deposition modeled.

28. The system according to claim 18, further comprising a heat cover connected to the at least two deposition print heads.

29. The system according to claim 28, wherein the heat cover comprises a heater.

30. (canceled)

31. (canceled)

32. (canceled)

33. (canceled)

34. (canceled)

35. (canceled)

36. The system according to claim 18, wherein the control unit is further arranged for controlling the positioning means, the at least two deposition printheads, and the at least one infrared radiation source for fused deposition modeling the at least one heating element as a heating layer around the fused deposition modeled object.
